(19) United States
(12) Patent Application Publication
(10) Pub. No.: US 2026/0219986 A1
(43) Pub. Date: Jul. 30, 2026

(54) ERROR DETECTION OR CORRECTION USING SIGNED PARITY CODES

(71) Applicant: Rivos Inc., Santa Clara, CA (US)

(72) Inventor: John G. Bennett, Sammamish, WA (US)

(21) Appl. No.: 19/137,171

(22) PCT Filed: Dec. 8, 2023
(86) PCT No.: PCT/US2023/083094

§ 371 Date: Jun. 9, 2025

Related U.S. Application Data
(60) Provisional application No. 63/386,844, filed on Dec. 9, 2022.

(51) Int. Cl. G06F 11/10

(52) U.S. Cl. CPC G06F 11/1004

(57) ABSTRACT

Systems and methods are described herein for efficient and low latency correction of single chip or single bounded block errors in a multichip memory system, using a signed parity mechanism to perform replacement or correction of erasures due to a fault, and to identify the correct symbol to be replaced. The mechanism has a high reliability of performing repair of faults which fall under the model, and a high probity of identifying uncorrectable errors.

### CROSS-REFERENCE TO RELATED APPLICATIONS

This application claims priority to U.S. Provisional Patent Application No. 63/386,844, filed on Dec. 9, 2022, the disclosure of which is incorporated by reference herein in its entirety.

### BACKGROUND

Data storage is an important aspect of computing devices. Computing devices may include one or more systems for storing data. Various data storage systems are used in computing devices. Some non-limiting examples of data storage devices include random access memories, such as static random access memories and dynamic random access memories, and persistent storage devices such as hard drives and solid state drives.

Modern computer systems rely on the integrity of stored data. Stored data may become corrupted while being written, stored, read, or transmitted. Error correction and error detection can be used to increase the integrity of data storage systems. Error detection allows for the detection of data that has been corrupted. Error correction allows for the correction of data that has been corrupted.

Memory devices such as Dynamic Random Access Memory (DRAM) may be arranged in redundant assemblies such that some portion of the data stored in the memory forms an error correction code. For example, at the chip level Double Data Rate 5 (DDR5) memory chips have two independent access channels, and 9 or 10 of these chips are further arranged into DRAM Inline Memory Modules (DIMM) where 8 of the chips carry the user data and an extra 1 or 2 chips carry redundant error correction codes (ECC). The ECC is present so that occasional errors in storing the data may be detected and almost always corrected, greatly improving the reliability of the system.

A DDR5 channel or subchannel (which may sometimes be referred to as a half-channel) may run more than 500 million stores or loads per second, and there can be 20 or more such channels connected to a CPU chip. Thus, billions of such operations may occur every second. Each of those operations should use a valid ECC mechanism to ensure reliable operation. It is important that the circuitry performing the ECC is small because many copies will be needed due to the number of channels and the need to calculate the ECC in both the store and load pathways. It is also important that the energy consumption should be low because billions of operations will be performed, and saving power depends on this efficiency. It is important that the formation of the ECC and the calculation of corrections occurs with minimal delay, since access to memory is one of the most critical paths adding to delay in computer operations.

The ECC operation must be trusted to correct errors within an error model. In DDR5, an important error model is multiple bit failures in a single chip. This is because single bit failures are corrected inside each chip, so these are not expected to be seen in the results. Multiple bit failures make up about 10% of the faults in modern DRAM chips and are usually caused by failures of structures within the DRAM which are shared by multiple bits, such as the conductive lines connecting a row of cells. Multiple bit errors may affect all the bits in the value held by one DRAM chip, as these bits are usually neighbors sharing a row line. However, errors of any kind are quite rare so it would be orders of magnitude rarer for more than one chip to have a multi-bit fault affecting any one operation. Thus, there is a need to provide ECC capable of correcting a multibit error in one chip.

Multibit errors within a chip may be either bounded, or unbounded. Bounded errors affect a limited number of bits in a request. Memory chips may be designed to bound errors by, for example, limiting the sharing of components that are more likely to fail to a subset (e.g., at most half) of the bits in a single request. In some memory arrangements, there may be fault boundaries which are not chips or half chips, but represent other structures which tend to cause multiple-faults to be held within those boundaries. In such systems the scheme for correcting faults within a chip becomes applicable by replacing “chip” by “bounded fault domain” or “bounded fault block” in applying the approach described here.

Redundant domains provide the additional bits used for ECC and with the correct configuration it will be possible to correct any or all the bits contributed by a single bounded fault domain. Unbounded errors can affect all bits of a request, but will be less likely to occur. This can result in ECC which can correct all bits in one chip (full chip correction), or which can correct half the bits in one chip (bounded correction).

It is important for ECC to report uncorrectable errors. The probability of detecting an error even if it cannot be corrected is the probity of the ECC. An uncorrectable error may be one with a rare pattern that defeats the ECC mechanism, or one which has errors outside the error model (such as on multiple chips, or a full chip failure that a bounded ECC cannot repair). Typical modern Reed-Solomon ECC has a probity of at least 99.9%, meaning that an uncorrectable error has less than 1 chance in a thousand of passing silently unreported. This number would be considered acceptable if the uncorrectable errors in production are expected to be a tiny fraction of all errors.

The extra bits of memory used to hold the ECC are useful for other purposes, such as storing metadata. These are generally bits used by hardware to implement functionality not directly seen by a program that uses the memory. These bits can be used to enforce privacy, help track shared memory, detect malicious behavior, and track past faults, among other things. Allocating bits for metadata use reduces the bits available for ECC capabilities, and so there is a tradeoff between metadata and ECC. This makes it important to have an ECC mechanism where the reliability and probity are clearly understood as a function of the number of bits used.

### SUMMARY

Systems and methods are described herein for efficient and low latency correction of single chip or single bounded block errors in a multichip memory system, using a signed parity mechanism to perform replacement of erasures due to a fault, and to identify the correct symbol to be replaced. The mechanism has a high reliability of performing repair of faults which fall under the model, and a high probity of identifying uncorrectable errors.

In some aspects, the techniques described herein relate to a data storage system including: a data storage assembly; and a signed parity code error correction system that is configured to: receive data from the data storage assembly, the data including a data block, a parity block, and a signature; calculate a signature for the data block and determine whether the calculated signature matches the signature included in the received data; calculate a parity for the data block and determine whether the calculated parity matches a parity of the received parity block. The signed parity code error correction system that is configured to, responsive to determining that the signature and the parity matches, return the received data block. The signed parity code error correction system that is configured to, responsive to determining that the parity does not match, generate a correction by: reconstructing sub-blocks of the received data block using the parity block; calculating updated signatures based on the reconstructed sub-blocks; and, responsive to determining that exactly one of the updated signatures matches the received signature, returning a corrected data block that incorporates the reconstructed sub-block corresponding to the matching updated signature.

Implementations can include one or more of the following features, alone or in any combination.

For example, the sub-blocks of the received data can correspond to bounded error domains of the data storage assembly.

In another example, the bounded error domains can be memory chips.

In another example, the bounded error domains can be memory chip subchannels.

In another example, each bit of the parity block can be calculated based on one bit from each sub-block.

In another example, the signature can be calculated using a separable operation.

In another example, the data block can include metadata.

In another example, the signed parity code error correction system can be further configured to: receive a second data block for storage in the data storage assembly; calculate a second signature for the second data block; calculate a second parity for the second data block; and store the second data block, second signature and second parity in the data storage assembly.

In another general aspect, the techniques described herein relate to a computing device including: at least one processing device; and any of the data storage systems of the aspects and examples recited above.

In some aspects, the techniques described herein relate to a computing device configured to: receive data to store in a memory; calculate a signature and parity block for the data; cause the data, signature, and parity block to be stored in the memory; and, responsive to receiving a request for the data: retrieve the data, signature, and parity block from the memory; recalculate the signature and parity block from the retrieved data; compare the retrieved signature and parity block with the recalculated signature and parity block. The computing device is further configured to, responsive to detecting a discrepancy between the retrieved signature and parity block with the recalculated signature and parity block: use the parity block to reconstruct each sub-block of the data retrieved from the memory as a candidate correction and a candidate signature for each reconstructed sub-block; responsive to determining that exactly one candidate correction results in a candidate signature that matches the retrieved signature, return corrected data based on the exactly one candidate correction; and responsive to determining that there is not exactly one candidate correction that results in a candidate signature that matches the retrieved signature, return an error.

Implementations can include one or more of the following features, alone or in any combination.

For example, the signature can be constructed by a separable arithmetic that assigns a unique bit pattern to each bit position in the data.

In another example, the signature is a pseudo-random permutation which is a repeatable but high entropy value which distills the overall data and metadata pattern.

In another example, the parity blocks can be constructed by a blockwise XOR of the data, metadata, and signature bits.

In another example, the blockwise XOR can be applied in a redundant manner that allows any one missing block to be reconstructed by a XOR of remaining blocks including the parity block.

In another example, the data can be retrieved incrementally from the memory and the signature and parity calculations can be performed on portions of the data as it is retrieved reducing a complexity and latency of calculations to be performed after the data is fully retrieved.

In another example, the signature values are calculated in parallel for each reconstructed sub-block by combining the signature of the reconstructed sub-block with previously calculated signatures for other sub-blocks.

In another example, candidate corrections can be evaluated in parallel to determine whether any one or more than one of those candidate corrections results in a matching signature.

In another example, the signature can be constructed based on assigning unique values to represent each different data bit position, where the unique values are identified by an exhaustive search of most likely fault patterns and of fault patterns with few bits, where the exhaustive search is used to discover faults where unique and distinctive values representing each data bit happen to combine in ways which cause two or more matches to be possible, causing one or several of those bit positions'values to be replaced with new unique and distinctive values and repeating the exhaustive search until it successfully evaluates all of the most likely fault patterns and all of the fault patterns with few bits.

In another example, the data stored in memory can include raw data and metadata.

In some aspects, the techniques described herein relate to a method of generating a signature code. The method includes: assigning bit patterns to each bit position of a data block, where each bit pattern is unique with respect to all of the other bit patterns; selecting a set of expected fault patterns; conducting an exhaustive search of the selected set of expected fault patterns to identify fault patterns in which the bit patterns representing each bit position of the data block combine in ways which cause two or more matches to be possible; replacing at least one of the bit patterns associated with a bit in fault in the identified fault patterns to be replaced with a new bit pattern; and repeating the steps of conducting the exhaustive search and replacing at least one of the bit patterns until the exhaustive search is completed without finding a combination that causes two or more matches.

Implementations can include one or more of the following features, alone or in any combination.

For example, the selecting a set of fault patterns can include selecting a set of fault patterns that includes most likely to occur fault patterns and fault patterns with few bits.

In another example, conducting an exhaustive search can include applying each of the fault patterns to the data block, attempting to correct the data block using signed parity correction, and determining whether multiple candidate corrections are found.

In another example, a set of available permutations of bit patterns can be significantly more numerous than the set of faults which merit the exhaustive search.

In another example, resulting bit patterns can be guaranteed to correct the faults which were selected in the set of expected fault patterns.

In some aspects, the techniques described herein relate to a method that includes: receiving data; calculating a signature for the data; calculating a parity block, where the parity block is calculated for the data and the signature; and storing the data, signature, and parity block in a memory.

Implementations can include one or more of the following features, alone or in any combination.

For example, the parity block can be calculated for the data.

In another example, the parity block can be calculated for the data and the signature.

In another example, the method can further include: receiving a request for the data; responsive to receiving the request for the data: retrieving the data, signature, and parity block from the memory; recalculating the signature and parity block from the retrieved data; comparing the retrieved signature and parity block with the recalculated signature and parity block; and responsive to detecting a discrepancy between the retrieved signature and parity block with the recalculated signature and parity block: using the parity block to reconstruct each sub-block of the data retrieved from the memory as a candidate correction and a candidate signature for each reconstructed sub-block; responsive to determining that exactly one candidate correction results in a candidate signature that matches the retrieved signature, returning corrected data based on the exactly one candidate correction; and responsive to determining that there is not exactly one candidate correction that results in a candidate signature that matches the retrieved signature, returning an error.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

FIG. 1 is a schematic block diagram of an example computing device that includes a data storage system that implements signed parity code error correction.

FIG. 2 is a schematic block diagram of an example data storage system that implements signed parity code error correction.

FIG. 3 is a schematic block diagram illustrating an example data flow through an example data storage system that implements signed parity code error correction.

FIG. 4 is a schematic block diagram of an example data storage system that is arranged for signed parity correction.

FIG. 5 is a schematic block diagram of an example data storage system that is arranged for signed parity correction.

FIG. 6 is a chart that illustrates an example signed parity code process being applied when any one chip is in fault.

FIG. 7 is a chart that illustrates an example signed parity code process being applied when multiple chips have faults (data errors).

FIG. 8 is a schematic illustration of an example system applying signed parity correction using 10 DDR DIMMs, 8 for data and 2 for redundancy.

FIG. 9 is a schematic illustration of the system described in FIG. 8 performing an example signed parity code ECC process when there are no chip failures.

FIG. 10 is a schematic illustration of the system described in FIG. 8 performing an example signed parity code ECC process when Chip 5 fails in a 10-over-8 DDR5 DIMM.

FIG. 11 is a schematic illustration of the system described in FIG. 8 performing an example signed parity code ECC process when Chip 8, which holds the parity value, fails in a 10-over-8 DDR5 DIMM.

FIG. 12 is a schematic illustration of the system described in FIG. 8 performing an example signed parity code ECC process when Chip 9, which holds the signature and metadata bits, fails in a 10-over-8 DDR5 DIMM.

FIG. 13 illustrates an example architecture of a computing device, which can be used to implement aspects according to the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates to systems and methods for data storage with error correction using a signed parity code (SPC). For example, error correction may be performed using a combination of parity bits and signature values.

The SPC includes a block of parity bits (sometimes referred to herein as a parity block) which can be used to repair a fault in the data spanning a length up to the same length as the parity block and a pseudo-random signature mechanism to confirm when the parity has been applied to the correct location. The signature can be a pseudo-random permutation which is a repeatable but high entropy value which distills the overall data and metadata pattern.

The parity block may be sized for a bounded fault error model or full chip error model. The signature will come out incorrect if the data contains a fault, causing the parity to be used to recalculate and replace data blocks at a variety of standard locations (the erasure points in ECC terminology) looking for one and only one such replacement to result in a matching signature. A benefit of this approach is that it is easy and quick to compute, compared to prior approaches such as Reed-Solomon (R-S) or Bose-Chaudhuri-Hocquenghem (BCH) codes. The SPC approach can be scaled to different sizes, changing the size of the parity block or the size of the signature, with predictable reliability and probity.

Beneficially, the signature size can be reduced to allow SPC to be used alongside metadata bits that are useful for other purposes.

The SPC approach scales in complexity approximately linearly with the number of bits of data and metadata. Additionally, the SPC approach is almost constant in energy per bit per transfer. In contrast, conventional symbol based ECC codes such as R-S scale quadratically or worse, which results in a perverse incentive to keep the data and metadata groups small. For example, current server computers using R-S on DDR4 or DDR5 memory usually run ECC on 32 bytes of data, even though there are 64 bytes in each store or load operation. Running the ECC algorithm twice allows these computers to limit the circuit size, power, and latency. However, this approach also limits the number of ECC bits available, which in turn limits the reliability and probity possible, crowding out any use of bits for metadata purposes. In contrast, an SPC operation can scale to the whole 64-byte transfer as a single ECC operation at only a slight increase in energy and latency, which doubles the available bits for ECC. Reliability and probity improve exponentially when more bits are available for the signature, resulting in levels far above need and thus freeing up a useful number of bits for metadata. In machines which use longer store and load operands, such as the 128 bytes or even 256 bytes operands used in very large memory arrays, the SPC approach described herein can be performed as a single ECC operation, allowing for very strong ECC and reduced overheads in the memory, even while supporting a good allotment of bits for metadata use.

Systems and methods are described herein relating to efficient implementation of a signed parity code (SPC) error correction mechanism. The technology may calculate a signature such that multiple parts of the data may be calculated in parallel, using any number and size of parts so long as the parts do not overlap (a separable calculation). A signature that is constructed using a separable calculation may be referred to herein as a separable signature. As non-limiting examples, the signature may be calculated with one part, which would be all the data and metadata together, or it may be calculated with the data and metadata in a first half and a second half, or it may be calculated with the data and metadata in each chip (or bounded fault domain) calculated separately. Other implementations may divide the data into parts differently or into a different number of parts.

Separable codes are related to commutative and transitive arithmetic operations such as addition and exclusive or (XOR). For example, a separable code may be constructed by assigning a distinct (unique) pseudo-random bit pattern to represent each bit position in the data and metadata and then adding or XORing all of the representative values together for each data or metadata bit that has the value 1. As used herein a distinct (or unique) bit pattern in the context of generating bit patterns for use in calculating signatures means that the bit pattern is not the same as (is different from) all of the bit patterns assigned to other bit positions. The pseudo-random bit pattern may be 32 bits or a different length. This signature will change if any data or metadata bit changes, but the calculation will be the same no matter how the additions or XORs are reordered.

Various types of separable codes are used in various implementations. Some implementations may use addition or XOR operations in generating a separable code. At least some implementations use a separable code based on an operation that preserves a distinct impact for every bit, avoids/reduces clustering of results, uses every bit of the signature evenly, and does not discard information.

An example of a separable function is addition. Addition loses high-end bits by overflow and uses the least significant bits less than the middle bits. It also has a tendency to cluster the result of many additions into a gaussian curve where some results are more likely than others. Some of these drawbacks can be mitigated by using a finite field which wraps overflow back into underflow, but that does not entirely even out the use of bits. Another separable operation is multiplication over a Galois field, which is used in B-C-H codes for ECC, which improves upon addition by having negligible central (clustering) tendencies. Both addition and multiplication are relatively slow operations with complex logic, but well understood.

Some implementations use XOR as a separable code. Beneficially, XOR requires a fraction of the logic to implement compared to operations like addition or multiply, potentially resulting in smaller chip sizes, lower power consumption, and lower latency. The mapping of each input bit to a distinct subset of signature bits can be performed so as to spread the bits, and the subsets can be chosen to give average equal weight to all signature bits. This approach has no centralizing (clustering) tendency and does not discard any bits or information.

The parity bits may also be generated using a separable calculation, such as XOR. Therefore, both the parity and the signature machinery of an SPC device may make use of separability. In some implementations, the parity bits are calculated by performing a blockwise XOR of all of the sub-block (bounded fault block) of the data.

At least some implementations disclosed herein may use separability to partially calculate results as the data arrives in each phase. For example, if the internal data rate delivers a 64-byte burst in 4 steps of 16 bytes each, partial calculations can begin as soon as each part of the data is available. In these implementations, the final calculations may be at least partially computed before all of the data has arrived, making the final result of the ECC on Store or on Load available with lower latency and/or making use of less aggressive and power-hungry logic.

Some implementations also use separability to prepare calculations in parallel for each chip or for each bounded domain. This approach may be especially beneficial for making a final correction. The correction is triggered if an error in parity or signature is observed when the recalculation of parity and signature in a load does not match the parity and signature retrieved from memory. The correction mechanism requires the parity difference to be applied to every chip or bounded domain that is designed to be corrected. With separability this calculation can be run in parallel for every chip or domain, and also due to separability the size of the logic needed for each parallel test is reduced to just the logic local to the signature from that chip or domain. This separability keeps the total logic to approximately the same size as the overall signature generation and it allows each such parallel check to be small and fast, for low latency.

This implementation guards against false corrections and detects uncorrectable faults by watching for the number of corrections claimed by the parallel search. The nature of the signature is that an N-bit signature algorithm for multiple bit errors will have roughly a 1 in 2^N chance of randomly being solved by the wrong bit pattern in the data. When this happens with any number of bits from the designed bounded domain it is a feature of the SPC approach that two possible solutions will be identified, not just one. One solution will be the parity is at fault, the other is the data. If N is large, this becomes a very rare uncorrectable but detected error. Only faults that have one possible solution are passed as solved. There are also some theoretical uncorrectable patterns where the same set of bits flipped by a fault in either of two chips might result in the same signature. For any given fault the chance of this ambiguity is also tiny, on the order of K/2^N where K is the number of chips or bounded domains that might be alternatives.

A common case of a DDR 5 DIMM with a 64-byte (512-bit) channel for data transfer uses 10 DDR5 chips with all chips operated in parallel to yield 640 bits (data plus ECC plus metadata bits) per access. In such a DIMM, N will generally be 48 or larger, while K=9. In this case, the chance of one of these aliases (uncorrectable patterns) is on the order of 1 in 10 trillion faults. If the SPC is designed for a 32-byte transfer on a 9-chip DDR with bounded faults, N will usually be 40 or larger while K is 35, so aliases would be expected to be less than one in 10 billion faults. Both of these greatly exceed basic requirements for reliability, and the uncorrected faults if they ever happen will be detected, not silent corruptions.

There is also the issue of the exceedingly rare faults that involve multiple bits from more than one chip or domain. These are unlikely to pass invisibly with the same 1 in 2^N improbability that such faulty patterns will just happen to match the correct signature. The probity of SPC thus is 99.999 . . . % for 10 or 13 9s in the above examples of DDR 5 configurations. It should be understood that implementations are also possible for other forms of memory too. For example, implementations are possible using any form of memory with enough spare bits to perform a classic Reed-Solomon ECC.

Some implementations also extend guarantees on correction to many additional common error cases (failure modes). For example, some implementations may guarantee that no uncorrectable bounded fault occurs, and that no combination of up to a total of M bits of error across any number of multiple chips will fail to be detected. In these implementations, the pseudo-random constants (bit patterns) assigned to each bit position are selected and tested against the error cases (failure modes). For example, a set of pseudo-random constants may be tested by enumerating all of the bounded faults and if any of those faults cannot be corrected, then one or more of the bits in that fault are assigned new pseudo-random constants and the test is rerun. This process may continue until all of the enumerated faults are corrected. The same approach is used for low bit-count faults on multiple chips. Such exhaustive searching will converge within a reasonable time if 2^N is much larger than the number of fault permutations to be certified. Beneficially, implementations that include these types of guarantees raise the minimum number of bits that need to be in a fault for an error to be uncorrectable. This process of selecting pseudo-random constants also allows for the use of fewer bits in each constant while still approaching 1 in 2^N reliability and probity, since only faults with higher counts of failing bits can be at risk and those signatures combine corresponding higher combinations of constants, which will make use of all available signature bits.

In some implementations, a signature is constructed based on assigning unique values to represent each different bit position of a data block, wherein the unique values are identified by an exhaustive search of the most likely fault patterns and of fault patterns with some small number of simultaneous fault bits. For example, a set of fault patterns may be selected based on expected errors. The exhaustive search may include testing the SPC error correction process described elsewhere herein on each of the selected fault patterns to discover if any of those fault patterns cannot be corrected because multiple possible correction candidates are found to be valid possible corrections (e.g., the multiple correction candidates result in a signature that matches). This situation with multiple possible candidates that match the signature is described further elsewhere herein and is sometimes referred to as a signature doppelganger. When the exhaustive search identifies at least one fault pattern that cannot be corrected, a new bit pattern will be generated for at least one of the bits in the fault pattern(s) that could not be corrected. The exhaustive search and bit pattern replacement process may be repeated until all of the fault patterns in the selected set of fault patterns can be corrected.

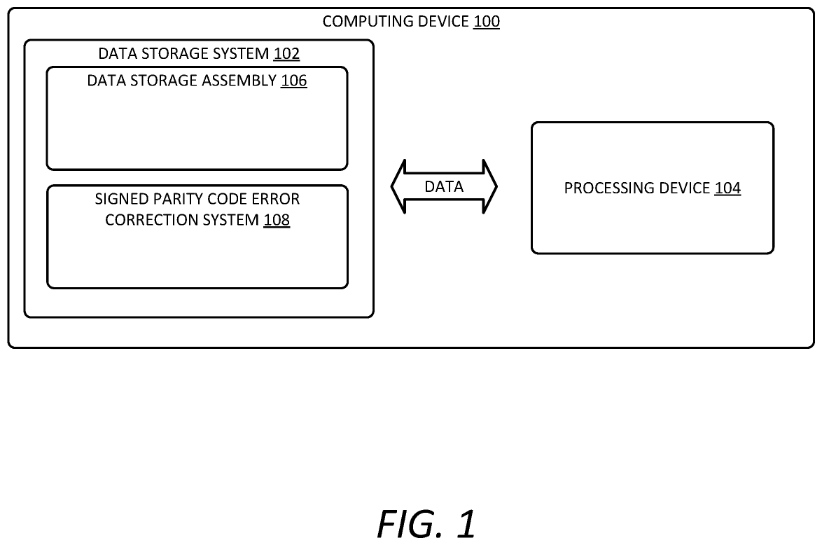

FIG. 1 is a schematic block diagram of an example computing device 100 that includes a data storage system 102 that implements signed parity code error correction. In this example, the computing device 100 includes the data storage system 102 and a processing device 104 that exchanges data with the data storage system 102. This diagram is greatly simplified to focus on the data storage system. The computing device 100 includes many other components that are not shown in this figure, such as an input/output interface.

The data storage system 102 is any type of system for storing data. Examples of the data storage system 102 include random access memories, such as static random access memories and dynamic random access memories, and persistent storage devices such as hard drives and solid state drives.

The data storage system 102 includes a data storage assembly 106 and a signed parity code error correction system 108. The data storage assembly 106 may include one or more physical devices for storing data, such as memory chips or drives. The signed parity code error correction system 108 includes logical components to implement the SPC methods disclosed herein with respect to data stored in the data storage assembly 106. In some implementations. The signed parity code error correction system 108 may be a component of a memory controller or drive controller or drive array controller. The signed parity code error correction system 108 may generate parity blocks and signatures that are stored along with corresponding data in the data storage assembly 106. The signed parity code error correction system 108 may also use the signatures and parity blocks to detect and correct errors in data stored in the data storage assembly 106 before transmitting the data to the processing device 104.

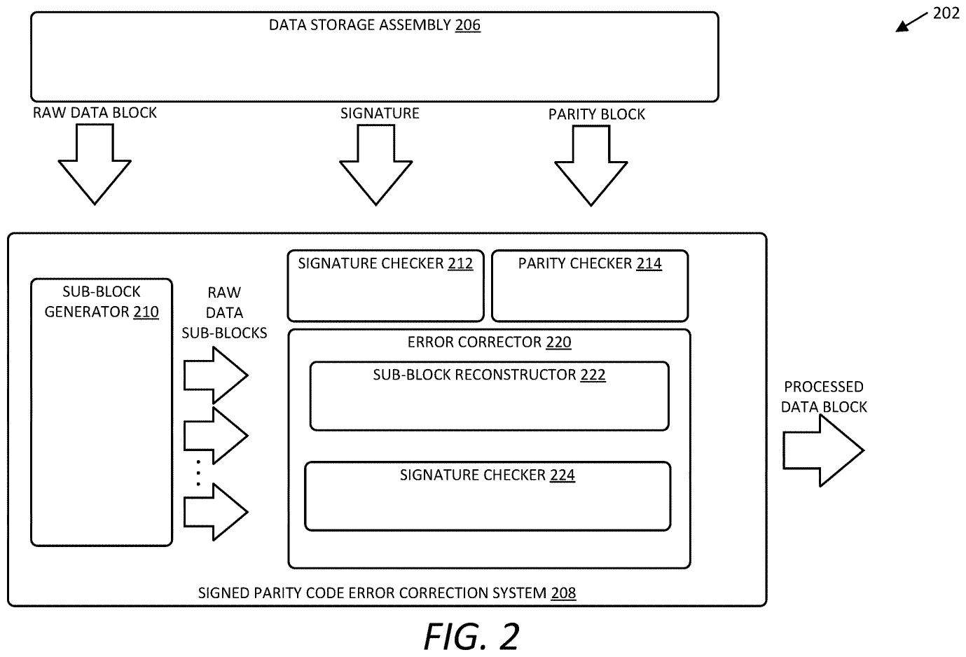

FIG. 2 is a schematic block diagram of an example data storage system 202 that implements signed parity code error correction. The data storage system 202 is an example of the data storage system 102. Here, the data storage system 202 includes a data storage assembly 206 and a signed parity code error correction system 208. The data storage assembly 206 and signed parity code error correction system 208 are examples of the data storage assembly 106 and signed parity code error correction system 108 respectively.

The data storage assembly 206 stores multiple data blocks and corresponding signatures and parity blocks. The data storage assembly 206 provides a raw data block and accompanying signature and parity block to the signed parity code error correction system 208 in response to data requests from, for example, a processing device or memory controller. In some implementations, a raw data block may include both data and metadata.

The signed parity code error correction system 208 then checks and, when necessary and possible, corrects the raw data block to generate the processed data block. Although not shown in this figure, the signed parity code error correction system 208 may also generate a data integrity signal, which may be used to indicate that the processed data block has been determined to be valid (e.g., that any detected errors were corrected) or invalid (e.g., the errors were detected and could not be corrected).

Example logical components of the signed parity code error correction system 208 along with an example logical data flow are shown in this figure. The signed parity code error correction system 208 includes a sub-block generator 210, a signature checker 212, a parity checker 214, and an error corrector 220.

The sub-block generator 210 generates data sub-blocks from the data received from the data storage assembly 206. In various implementations, various different sizes and quantities of sub-blocks are generated. The sub-blocks are sized such that an entire sub-block can be regenerated using a parity block received from the data storage assembly 206. In some implementations, the sub-blocks are the same size as the parity block so that each bit in the parity block can be used to check a bit in the sub-block. In some implementations, the sub-blocks are smaller than the parity block. The sub-blocks may correspond to a bounded domain (a bounded-fault block) within the data storage assembly (e.g., portions of the raw data block that come from a region of the data storage assembly that could potentially suffer from the same failure, impacting the integrity of the entire region). As discussed further herein, in response to detecting an error based on the signature or parity block, the signed parity code error correction system 208 will attempt to replace one of the sub-blocks with a reconstructed sub-block based on the parity block.

In some implementations, the sub-block generator 210 passively identifies sub-blocks in the raw data block (e.g., by identifying ranges of the raw data block for further processing). Alternatively or additionally, sub-blocks may be copied from the raw data block to one or more sub-block data arrays or buffers. In some implementations, the raw data block is received in a stream and is received incrementally, where one or more sub-blocks are received at a time. In these implementations, the sub-block generator 210 may provide sub-blocks to the other components of the signed parity code error correction system 208 as the sub-blocks are received.

The signature checker 212 generates a signature for the raw data block and compares the generated signature to the signature received from the data storage assembly 206. In response to determining that the generated signature does not match the received signature, the signature checker 212 determines that there is a data integrity error in the raw data block, triggering the error corrector 220 to attempt to correct the raw data block. In some implementations, the signature is generated using a separable operation and the signature checker 212 generates a signature using signature values that have been generated separately for each of the sub-blocks.

The parity checker 214 checks for parity errors in the raw data block using the parity block received from the data storage assembly 206. The parity block may be the same size as the sub-blocks, and the parity values may be checked based on bit position within each sub-block. Detection of a parity error will indicate which bits in the parity block do not match the expected parity for the sub-blocks, but not which sub-block has an incorrect value. In response to determining that there is a parity error in the raw data block, the parity checker 214 may trigger the error corrector 220 to attempt to correct the raw data block by using the signature to identify and correct the sub-block with the incorrect value.

The error corrector 220, attempts to correct errors in the raw data block using the signature and parity block from the data storage assembly 206. Here, the error corrector 220 includes a sub-block reconstructor 222 and a signature checker 224.

The sub-block reconstructor 222 reconstructs a sub-block using the parity block and the values of some or all of the other sub-blocks. For example, if the parity block is the same size as the sub-blocks, the value of each bit in a single sub-block that would result in the expected parity value that matches the parity block can be determined (e.g., using an XOR operation).

The signature checker 224 generates a signature using one reconstructed sub-block and the remaining original sub-blocks. If the signature matches the signature value received from the data storage assembly 206, the reconstructed sub-block is determined to be a solution to the error in the raw data block because this data will now satisfy the parity and signature checks. This reconstructed sub-block may be included in the processed data block.

In implementations that use a separable signature, the signature values generated for the raw sub-blocks may be stored (e.g., in a buffer) and combined with a signature value generated for the reconstructed sub-block to more efficiently generate signature values for data blocks that include reconstructed sub-blocks.

The signature checker 224 performs an operation that is logically similar to the operation performed by the signature checker 212, except that the signature checker 224 uses a single reconstructed sub-block and the remaining raw data sub-blocks. In contrast, the signature checker 212 uses only the raw data sub-blocks. Although shown as separate components in this figure, in some implementations, the signature checker 212 and signature checker 224 are actually the same component.

The error corrector 220 may attempt to correct errors in the raw data block by independently reconstructing each of the data sub-blocks using the parity block and checking whether the correct signature value is generated using the one reconstructed sub-block and all of the other raw sub-blocks. In some implementations, each sub-block is reconstructed and tested in parallel. When exactly one sub-block reconstruction is found to generate the matching signature, a processed data block is generated that includes that reconstructed sub-block. If the signatures generated from more than one of the reconstructed sub-blocks are found to match the signature from the data storage assembly 206, the error corrector 220 may determine that the error is uncorrectable and generate a signal to indicate this error state.

In some implementations, the error corrector 220 operates on all raw data blocks but the results are only checked and used if the signature checker 212 or parity checker 214 indicate an error in the raw data block. Alternatively, the error corrector 220 may only operate on raw data blocks for which the signature checker 212 or parity checker 214 indicate that an error has occurred.

As discussed previously, a raw data block, a signature, and a parity block are all retrieved from the data storage assembly 206. The signature and parity block may be generated during store operations by the data storage system 202. For example, the raw data block may include user (application) data alone or may also include metadata. During a store (write) operation, a signature may be generated based on the raw data block. Additionally, a parity block may be generated for the raw data block. The raw data block may be stored across multiple bounded fault domains (or channels) within the data storage assembly. The parity block may be generated such that each bit in the parity block represents the parity of a set of one bit selected from each of the bounded fault domains (channels). The signature may be generated for the raw data block and may be stored in one or more of the bounded fault domains. In some implementations, the signature does not use all of the bits in a bounded fault domain and the remaining bits may be allocated for metadata. In some implementations, the parity block is generated based on the raw data and the signature.

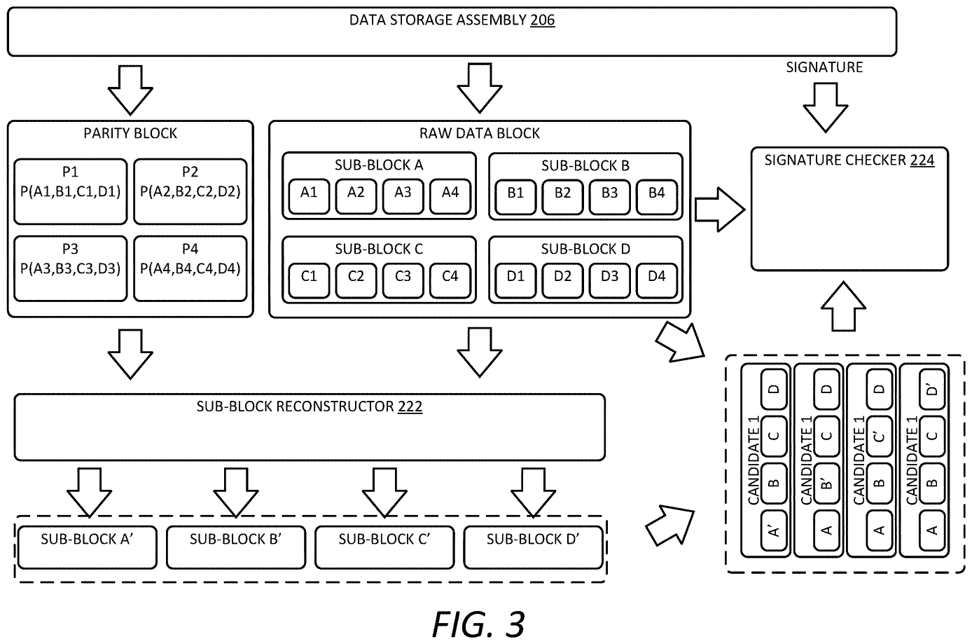

FIG. 3 is a schematic block diagram illustrating an example data flow through an example data storage system that implements signed parity code error correction. This example is simplified to illustrate the concepts of signed parity code error correction. Here, a 16-bit raw data block, a parity block, and a signature is received from the data storage assembly 206. The raw data block includes four 4-bit sub-blocks A, B, C, and D. The sub-blocks may each correspond to data stored on different chips, channels, or bounded fault domains in the data storage assembly 206.

In this example, the parity block is 4 bits, wherein each bit is generated based on one corresponding bit from each of the sub-blocks. For example, parity bit P1 is generated from bits A1, B1, C1, and D1. Parity bits P2, P3, and P4 are generated similarly. Various implementations will use various bit lengths for the signature. In this example, the signature length is not specified. The signature would typically be longer than 4 bits so as to provide a reasonable chance of being distinctive for various data values that are being stored. As described elsewhere herein, the length of the signature may be selected to balance the greater likelihood of distinctiveness with longer signature values against the availability of memory for other uses with shorter signature values.

The sub-block reconstructor 222 generates reconstructed sub-blocks A′, B′, C′, and D′ using the other sub-blocks and the parity block. For example, reconstructed sub-block A′ is generated from sub-blocks B, C, and D and the parity block. Reconstructed sub-blocks B′, C′, and D′ are generated in a similar manner.

Correction candidates are then generated using exactly one of the reconstructed sub-blocks and the other raw sub-blocks. For example, Candidate 1 includes the reconstructed sub-block A′ and the raw sub-blocks B, C, and D; Candidate 2 includes the reconstructed sub-block B′ and the raw sub-blocks A, C, and D; Candidate 3 includes the reconstructed sub-block C′ and the raw sub-blocks A, B, and D; and Candidate 4 includes the reconstructed sub-block D′ and the raw sub-blocks A, B, and C.

The signature checker 224 calculates a signature for each of the candidates and compares that signature to the signature received from the data storage assembly 206. If a signature from one and only one of the candidates matches, that candidate may be used as the processed (corrected) data.

In some implementations, the signature checker 224 does not calculate the signature for the entire candidate. Instead, when the signature calculation is separable, a difference between the portion of the signature generated for the raw sub-block and the signature generated for the reconstructed sub-block is determined. If this difference is equal to the difference between the signature received from the data storage assembly 206 and the signature calculated for the raw data block, the reconstructed sub-block is considered a match (i.e., a valid potential correction).

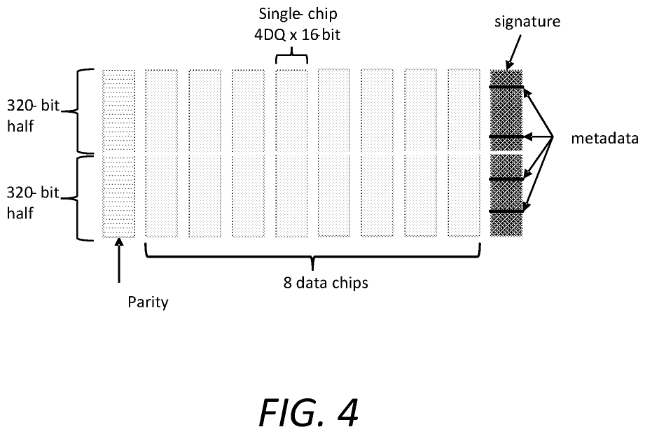

FIG. 4 is a schematic block diagram of an example data storage system that is arranged for signed parity correction. This figure shows a possible bit allocation plan for 64 bytes of data and 4 bits of metadata in a 10-chip DDR 5 subchannel, showing the 1st and 10th chips used for metadata, signature, and parity, organized for processing as first and second half bursts of data, in accordance with at least one embodiment.

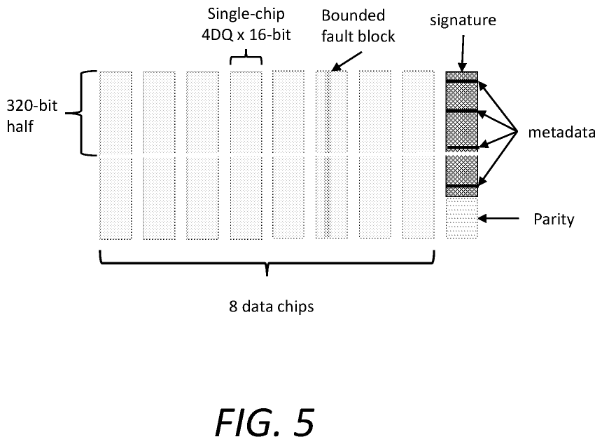

FIG. 5 is a schematic block diagram of an example data storage system that is arranged for signed parity correction. This figure shows a possible bit allocation plan for 64 bytes of data and 4 bits of metadata in a 9-chip DDR 5 subchannel, showing the 9th chip used for metadata, signature, and bounded-fault parity, organized for processing as first and second half bursts of data, in accordance with at least one embodiment.

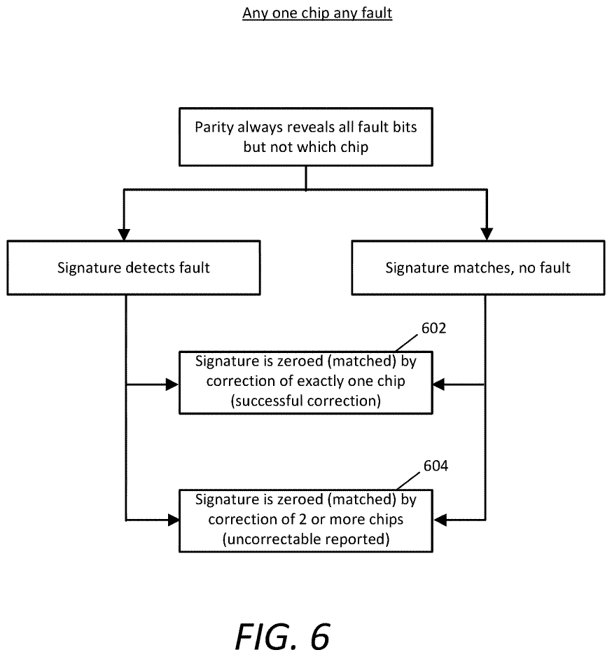

FIG. 6 is a chart that illustrates an example signed parity code process being applied when any one chip is in fault. As an initial note, if there are no faults in the data, then both the parity and the signature will match for all bits and the data can be returned without need for any data correction.

In the case of a single chip fault (or single bounded fault block), the parity bits will reveal that a fault has occurred. In most situations, the signature will also detect a fault but in some cases it may not due to the doppelganger situation described below. In any case when the parity indicates a fault, corrections will be applied to each chip (or sub-block) independently using the parity bits.

If the signature matches with exactly one of these corrections (602), that correction will be included in the returned data. This situation occurs when there is bad data from a single chip that can be corrected properly. This situation is the most common case for a single chip fault.

If multiple of the corrections result in a signature that matches (604), it is not possible to determine which correction is correct and an uncorrectable error will be reported. The multiple matching corrections are a result of a signature doppelganger where two different data sequences result in the same signature. This situation occurs by chance with order N/(2^K), where N is the number of chips (or bounded-fault blocks) and K is the number of bits in the signature. Since both chips are calculated to be candidates for the failure (i.e., they both have a signature match when corrected), it is not possible to determine which chip to correct. This situation is detected and reported.

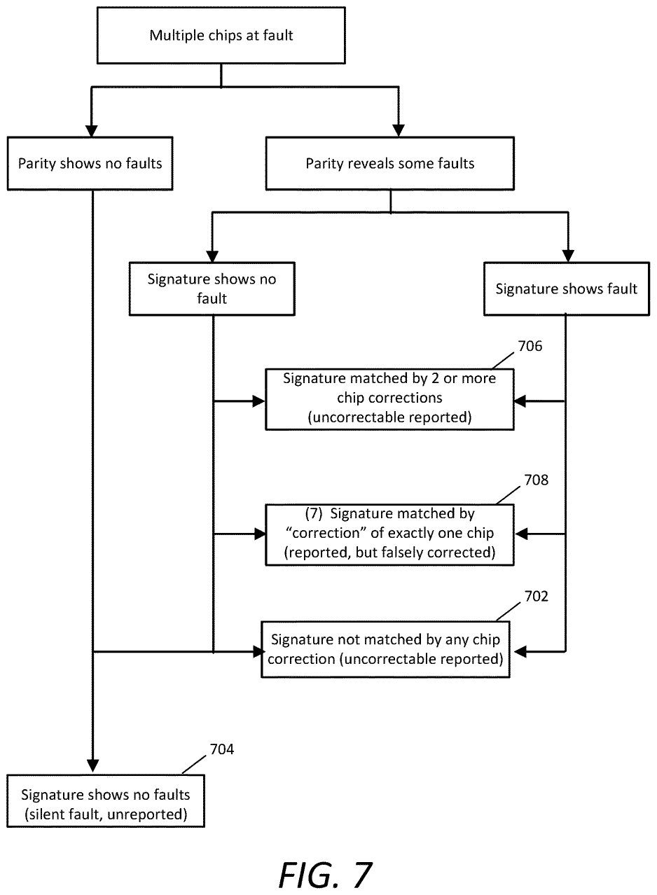

FIG. 7 is a chart that illustrates an example signed parity code process being applied when multiple chips have faults (data errors).

When multiple chips have faults, the parity bits may not always reveal the error. For example, if the bits on two chips are all flipped, the parity will not be impacted. If multiple chips have faults and the parity does not detect the error, in most cases the signature will still detect an error. When the signature detects an error even though the parity bits do not, it will not be possible to use the parity bits to generate a correction for a chip (or bounded-fault blocks). In this situation, an uncorrectable error is reported (702). This is a multichip uncorrectable error and it is detected and reported. Because this error is detected and reported, it is a safe result for an error type that is not expected to be corrected. This situation is by far the most common result for any multi-chip fault.

In some cases, however, the corrupted data may be a signature doppelganger of the original data, resulting in a matching signature (704). This situation occurs by chance with order N/(2^K), where N is the number of chips (or bounded-fault blocks) and K is the number of bits in the signature. Since the parity bits and signature both match, no fault will be detected and the data will be returned without any indication of corruption.

If instead, the parity does reveal faults, corrections will be applied to each chip (or bounded-fault block) independently using the parity bits. Three outcomes are possible when the reality is that faults occurred in multiple blocks. First, two or more of the corrections may independently result in a signature match, causing an uncorrectable error to be reported (706). This is another version of a doppelganger false correction. Here, two or more chips generate an apparent correction. This situation is rare with a probability of occurrence on the order of N/(2^(2K)). This situation is always detected as a failure, and safely reported as an uncorrectable error.

Second, exactly one of the corrections may independently result in a signature match, causing the correction to be incorporated into the data and the data to be returned. In this situation, because there were actually multiple faults, the correction would be wrong but the data is returned and reported as being corrected (708). This false correction occurs because a random solution matches the signature. It results in a silent, unreported failure. The probability of this failure occurring is on the order of N/(2^K).

Third, none of the corrections will independently result in a signature that matches. In this situation, an uncorrectable error is reported (702), which has been described previously.

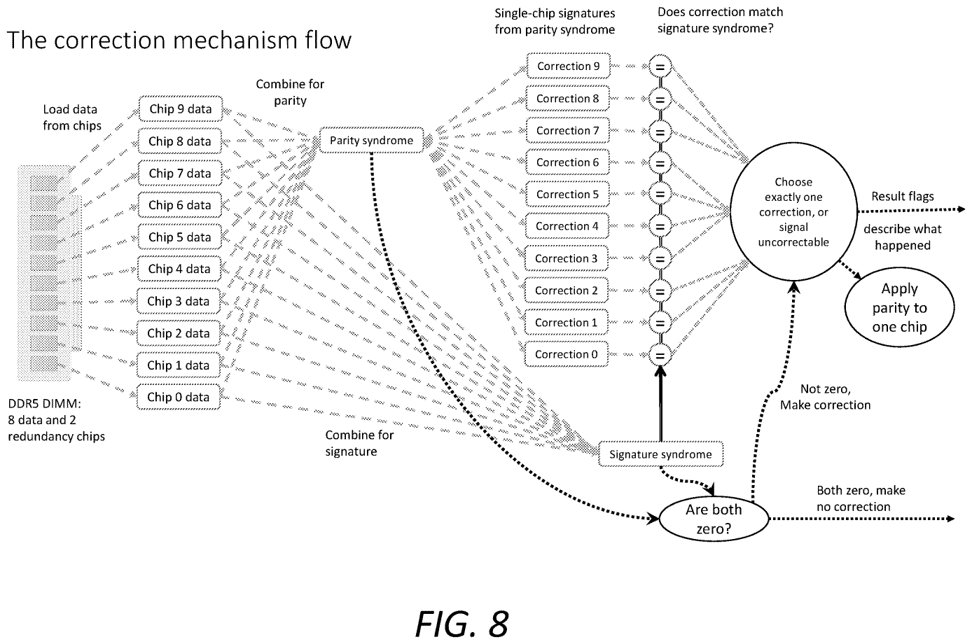

FIG. 8 is a schematic illustration of an example system applying signed parity correction using 10 DDR DIMMs, 8 for data and 2 for redundancy. This arrangement of DDR DIMMs may be referred to as a 10-over-8. In this example, the data is read from all of the chips and the data from each chip is treated as a sub-block for signed parity correction purposes. The data from all of the chips is combined to determine a parity syndrome (i.e., a difference between the stored parity and the calculated parity). The data from all of the chips is also combined to determine a signature syndrome (i.e., a difference between the stored signature and the calculated signature). If both the parity syndrome and the signature syndrome are zero, the data is returned without correction. If one or both of the parity syndrome and the signature syndrome are non-zero, a correction is generated for each sub-block (data from a chip) based on the parity bits and the signature syndrome is recalculated using each of the corrections independently. If exactly one of the corrections zeros the signature syndrome, that correction is incorporated and the corrected data is returned along with an indication that the correction occurred. Otherwise, an uncorrectable error signal is returned instead.

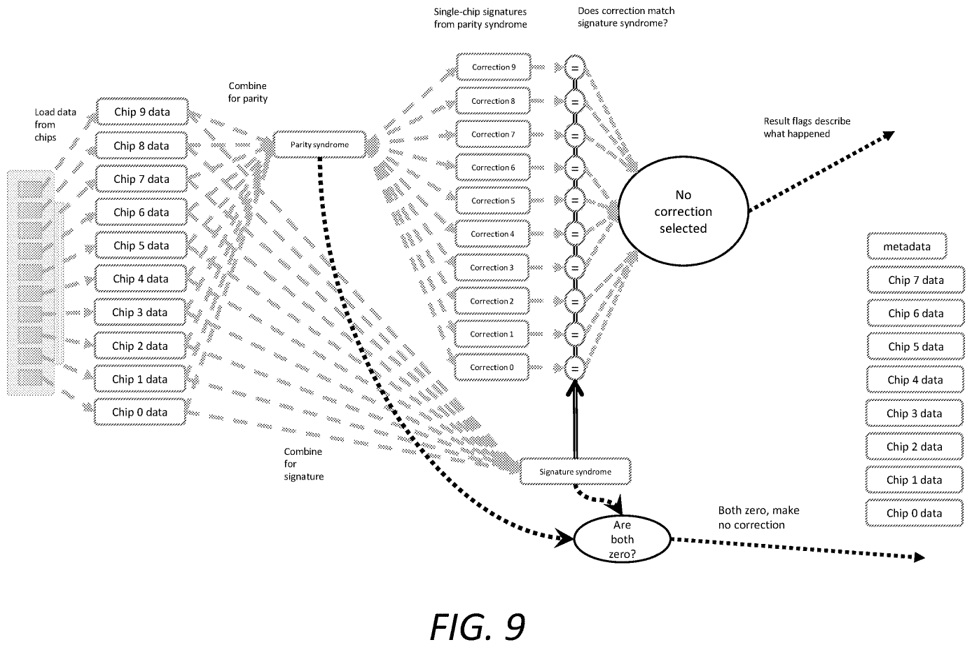

FIG. 9 is a schematic illustration of the system described in FIG. 8 performing an example signed parity code ECC process when there are no chip failures. The calculation of parity is zero if all chips are correct, since Chip 8 is the parity of the other 9 chips. The data and metadata in the incoming chip values is correct so the signature calculation equals the signature loaded from the chips. The signature syndrome is the difference relative to the syndrome seen loaded from the DIMM, so the syndrome will be zero. As both the signature and the parity syndromes are zero no changes to data are made and the data and metadata is passed through with the values loaded from DRAM.

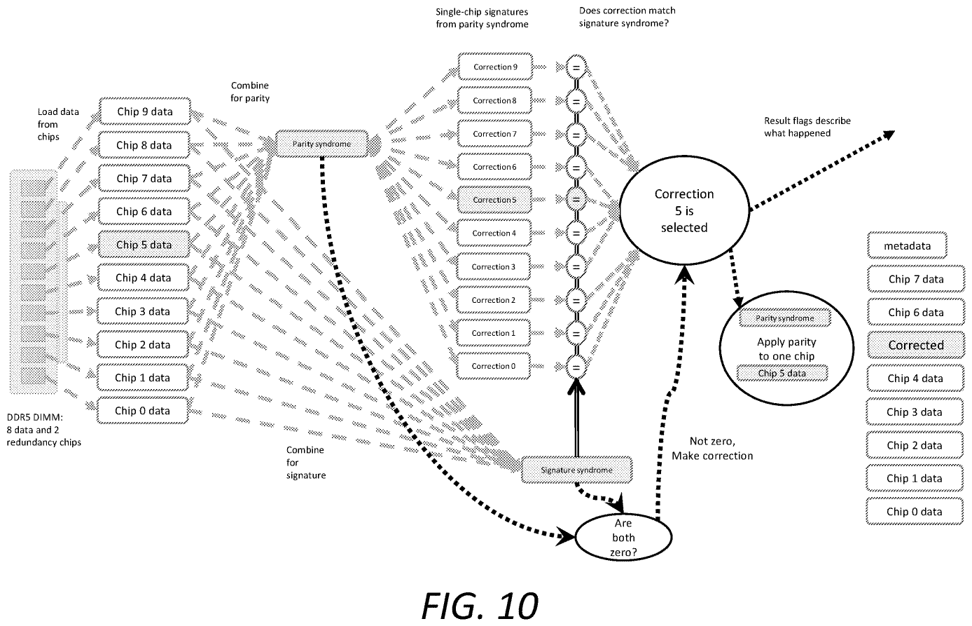

FIG. 10 is a schematic illustration of the system described in FIG. 8 performing an example signed parity code ECC process when Chip 5 fails in a 10-over-8 DDR5 DIMM. The calculation of parity would be zero if all chips are correct, since Chip 8 is the parity chip of the other 9 chips in this example. Instead, the bit flips due to failure in Chip 5 will flip the corresponding parity bits, forming a non-zero parity syndrome. The bit flips in the incoming value of Chip 5 will also contribute to a different signature syndrome-the syndrome is the difference relative to the signature loaded from the DIMM. Due to separability the signature syndrome is equal to the signature of the bits flipped in Chip 5.

Those flips in turn result in the non-zero parity syndrome bits. The parity syndrome is run through the separable single chip signatures of each of the 10 chips. When the signature calculation of Chip 5 is calculated it is found to be equal to the signature syndrome, it is clear that Chip 5 is a candidate for correction. Since all other chips'calculations are different and unlikely to generate a match, there is exactly one candidate. The parity syndrome is used to reverse the flips in Chip 5 data to yield correct output.

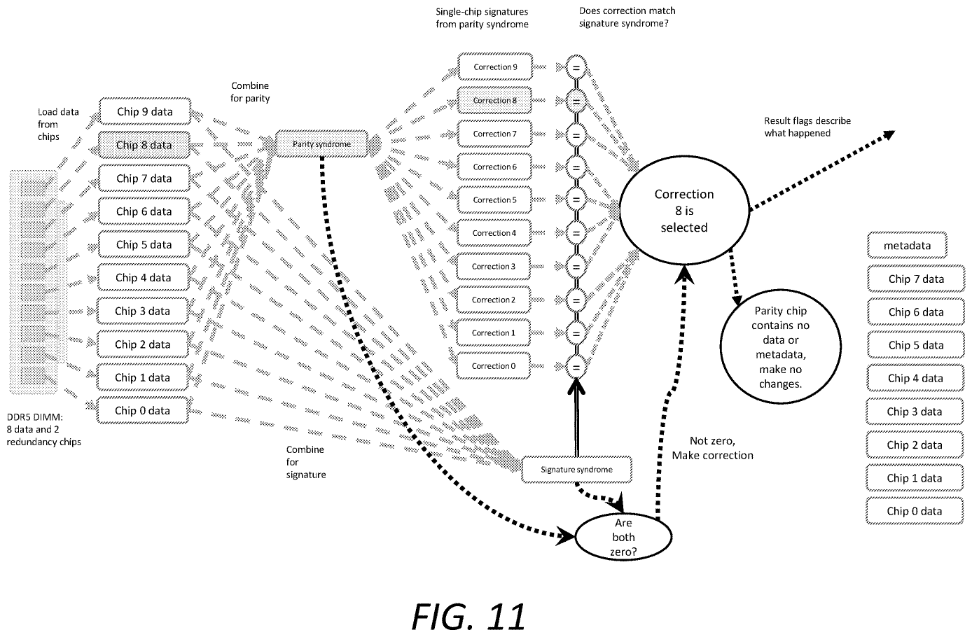

FIG. 11 is a schematic illustration of the system described in FIG. 8 performing an example signed parity code ECC process when Chip 8 fails in a 10-over-8 DDR5 DIMM. Chip 8 is the parity of the other 9 chips. Instead of providing an accurate parity, the bit flips due to failure in Chip 8 will flip the corresponding parity bits, forming a non-zero parity syndrome. The parity is calculated after the signature, and parity bits do not contribute to the signature. When chip 8 is faulty the signature syndrome remains zero. The parity syndrome is run through the separable single chip signatures of each of the 10 chips.

When the signature calculation of Chip 8 is zero and it is likely that all other chip calculations will not be zero, it is clear that Chip 8 is the only candidate for correction. Parity is not returned to the user. When Chip 8 is the sole chip to match the signature syndrome no correction needs to be made to data or metadata but the failure may be reported in the results flags in some implementations.

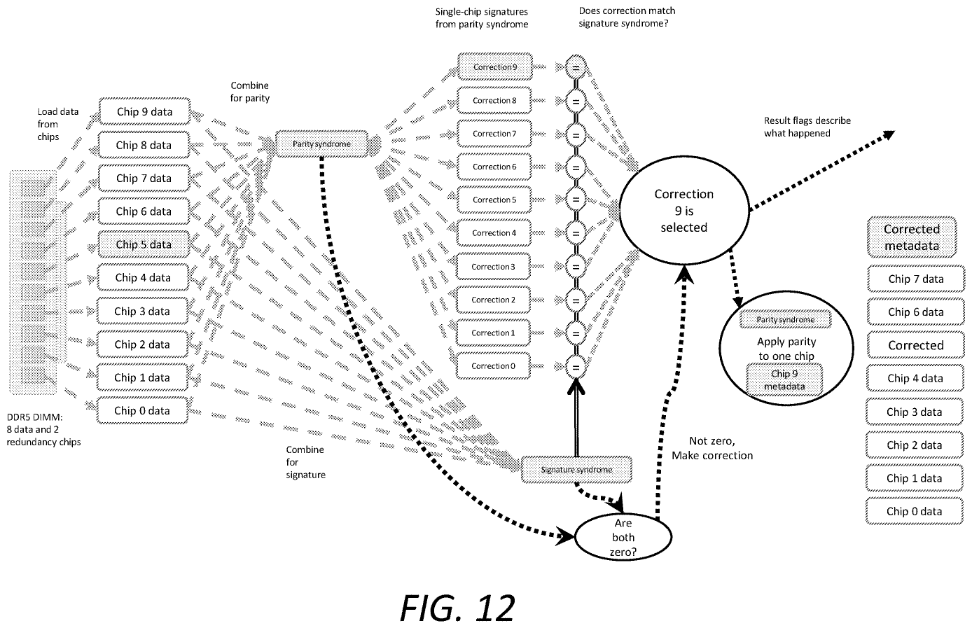

FIG. 12 is a schematic illustration of the system described in FIG. 8 performing an example signed parity code ECC process when Chip 9 fails in a 10-over-8 DDR5 DIMM. Chip 9 contains metadata and signature. The bit flips due to failure in Chip 9 will flip the corresponding parity bits forming, a non-zero parity syndrome. The signature calculation of Chip 9 may use an identity function for the signature bits themselves. An identity function returns the same value as its input (i.e., the signature generated for the signature bits is the signature bits). This identity function ensures that the parity syndrome will correctly match the signature syndrome when run through the Chip 9 calculation. Due to separability the signature syndrome is equal to the signature calculation of the bits flipped in Chip 9. Those flips in turn are equal to the non-zero parity syndrome bits.

The parity syndrome is run through the separable single chip signatures of each of the 10 chips. When the signature calculation of Chip 9 is calculated it is found to be equal to the signature syndrome, it is clear that Chip 9 is a candidate for correction. Since all other chips have different calculations unlikely to generate a match, there is exactly one candidate. The parity syndrome is used to reverse the flips in Chip 9 metadata to yield correct output.

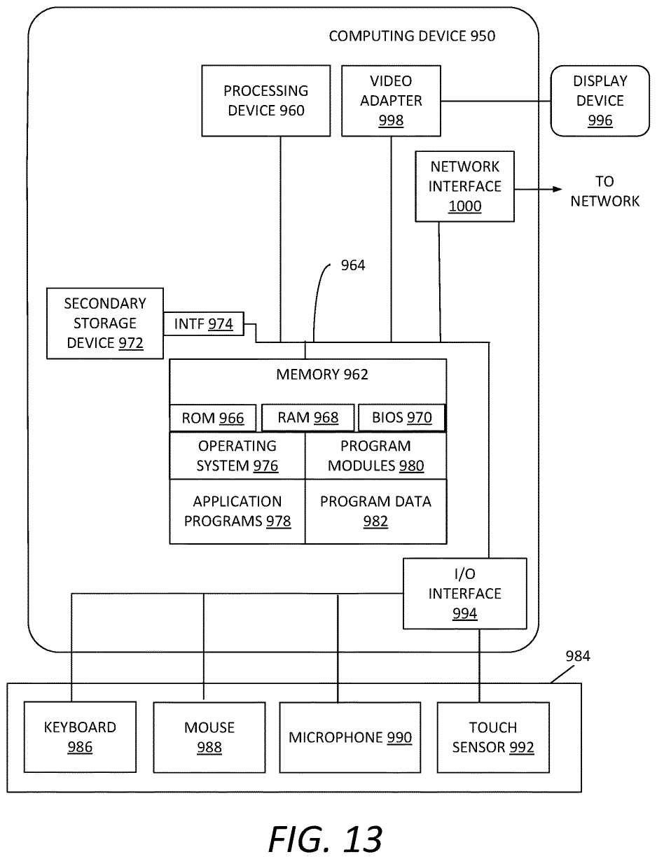

FIG. 13 illustrates an example architecture of a computing device 950 that can be used to implement aspects of the present disclosure, including any of the plurality of computing devices described herein, such as the computing device 100 or any other computing devices that may be utilized in the various possible embodiments, such as computing devices that are used to perform processes of generating and testing pseudo-random constants for use in signatures.

The computing device illustrated in FIG. 13 can be used to execute the operating system, application programs, and software modules described herein.

The computing device 950 includes, in some embodiments, at least one processing device 960, such as a central processing unit (CPU). A variety of processing devices are available from a variety of manufacturers. In this example, the computing device 950 also includes a system memory 962, and a system bus 964 that couples various system components including the system memory 962 to the processing device 960. The system bus 964 is one of any number of types of bus structures including a memory bus, or memory controller; a peripheral bus; and a local bus using any of a variety of bus architectures.

Examples of computing devices suitable for the computing device 950 include a server computer, an edge computer, a controller for a memory or storage system operating as a peripheral device (e.g., a disaggregated memory or storage device), a desktop computer, a laptop computer, a tablet computer, a mobile computing device (such as a smartphone or other mobile devices), or other devices configured to process digital instructions.

The system memory 962 includes read only memory 966 and random-access memory 968. A basic input/output system 970 containing the basic routines that act to transfer information within computing device 950, such as during start up, is typically stored in the read only memory 966.

The computing device 950 also includes a secondary storage device 972 in some embodiments, such as a hard disk drive, for storing digital data. The secondary storage device 972 is connected to the system bus 964 by a secondary storage interface 974. The secondary storage devices 972 and their associated computer readable media provide nonvolatile storage of computer readable instructions (including application programs and program modules), data structures, and other data for the computing device 950.

Although the example environment described herein employs a hard disk drive as a secondary storage device, other types of computer readable storage media are used in other embodiments. Examples of these other types of computer readable storage media include solid-state drives, magnetic cassettes, flash memory cards, digital video disks, Bernoulli cartridges, compact disc read only memories, digital versatile disk read only memories, random access memories, or read only memories. Some embodiments include non-transitory computer-readable media. Additionally, such computer readable storage media can include local storage or cloud-based storage.

A number of program modules can be stored in secondary storage device 972 or system memory 962, including an operating system 976, one or more application programs 978, other program modules 980 (such as the software engines described herein), and program data 982. The computing device 950 can use any suitable operating system, such as Microsoft Windows™, Google Chrome™ OS or Android, Apple MacOS™ or iOS™, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 950 through one or more input devices 984. Examples of input devices 984 include a keyboard 986, mouse 988, microphone 990, and touch sensor 992 (such as a touchpad or touch sensitive display). Other embodiments include other input devices 984. The input devices are often connected to the processing device 960 through an input/output interface 994 that is coupled to the system bus 964. These input devices 984 can be connected by any number of input/output interfaces, such as a parallel port, serial port, game port, or a universal serial bus. Wireless communication between input devices and the interface 994 is possible as well, and includes infrared, BLUETOOTH® wireless technology, 802.11a/b/g/n, cellular, ultra-wideband (UWB), ZigBee, or other radio frequency communication systems in some possible embodiments.

In this example embodiment, a display device 996, such as a monitor, liquid crystal display device, projector, or touch sensitive display device, is also connected to the system bus 964 via an interface, such as a video adapter 998. In addition to the display device 996, the computing device 950 can include various other peripheral devices (not shown), such as speakers or a printer.

When used in a local area networking environment or a wide area networking environment (such as the Internet), the computing device 950 is typically connected to the network through a network interface 1000, such as an Ethernet interface or WiFi interface.

Other possible embodiments use other communication devices. For example, some embodiments of the computing device 950 include a modem for communicating across the network.

The computing device 950 typically includes at least some form of computer readable media. Computer readable media includes any available media that can be accessed by the computing device 950. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 950.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 13 is also an example of programmable electronics, which may include one or more such computing devices, and when multiple computing devices are included, such computing devices can be coupled together with a suitable data communication network so as to collectively perform the various functions, methods, or operations disclosed herein.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A data storage system comprising:
a data storage assembly; and
a signed parity code error correction system configured to:
receive data from the data storage assembly, the data including a data block, a parity block, and a signature;
calculate a signature for the data block and determine whether the calculated signature matches the signature included in the received data;
calculate a parity for the data block and determine whether the calculated parity matches a parity of the received parity block;
responsive to determining that the signature and the parity matches, return the received data block;
responsive to determining that the parity does not match, generate a correction by:
reconstructing sub-blocks of the received data block using the parity block;
calculating updated signatures based on the reconstructed sub-blocks; and
responsive to determining that exactly one of the updated signatures matches the received signature, returning a corrected data block that incorporates the reconstructed sub-block corresponding to the matching updated signature.

2. The data storage system of claim 1, wherein the sub-blocks of the received data correspond to bounded error domains of the data storage assembly.

3. The data storage system of claim 2, wherein the bounded error domains are memory chips.

4. The data storage system of claim 2, wherein the bounded error domains are memory chip subchannels.

5. The data storage system of any one of claims 1-4, wherein each bit of the parity block is calculated based on one bit from each sub-block.

6. The data storage system of any one of claims 1-5, wherein the signature is calculated using a separable operation.

7. The data storage system of any one of claims 1-6, wherein the data block includes metadata.

8. The data storage system of any one of claims 1-7, wherein the signed parity code error correction system is further configured to:
receive a second data block for storage in the data storage assembly;
calculate a second signature for the second data block;
calculate a second parity for the second data block; and
store the second data block, second signature and second parity in the data storage assembly.

9. A computing device comprising:
at least one processing device; and
the data storage system of any one of claims 1-8.

10. A computing device configured to:
receive data to store in a memory;
calculate a signature and parity block for the data;
cause the data, signature, and parity block to be stored in the memory; and
responsive to receiving a request for the data:
retrieve the data, signature, and parity block from the memory;
recalculate the signature and parity block from the retrieved data;
compare the retrieved signature and parity block with the recalculated signature and parity block; and
responsive to detecting a discrepancy between the retrieved signature and parity block with the recalculated signature and parity block:
use the parity block to reconstruct each sub-block of the data retrieved from the memory as a candidate correction and a candidate signature for each reconstructed sub-block;
responsive to determining that exactly one candidate correction results in a candidate signature that matches the retrieved signature, return corrected data based on the exactly one candidate correction; and
responsive to determining that there is not exactly one candidate correction that results in a candidate signature that matches the retrieved signature, return an error.

11. The computing device of claim 10, wherein the signature is constructed by a separable arithmetic that assigns a unique bit pattern to each bit position in the data.

12. The computing device of claim 11, wherein the signature is a pseudo-random permutation which is a repeatable but high entropy value which distills the overall data and metadata pattern.

13. The computing device of any one of claims 10-12, wherein the parity blocks are constructed by a blockwise XOR of the data, metadata, and signature bits.

14. The computing device of claim 13, wherein the blockwise XOR is applied in a redundant manner that allows any one missing block to be reconstructed by a XOR of remaining blocks including the parity block.

15. The computing device of any one of claims 10-14, wherein the data is retrieved incrementally from the memory and the signature and parity calculations are performed on portions of the data as it is retrieved reducing a complexity and latency of calculations to be performed after the data is fully retrieved.

16. The computing device of any one of claims 10-15, wherein signature values are calculated in parallel for each reconstructed sub-block by combining the signature of the reconstructed sub-block with previously calculated signatures for other sub-blocks.

17. The computing device of any one of claims 10-16, wherein candidate corrections are evaluated in parallel to determine whether any one or more than one of those candidate corrections results in a matching signature.

18. The computing device of any one of claims 10-17, wherein the signature is constructed based on assigning unique values to represent each different data bit position, wherein the unique values are identified by an exhaustive search of most likely fault patterns and of fault patterns with few bits, wherein the exhaustive search is used to discover faults where unique and distinctive values representing each data bit happen to combine in ways which cause two or more matches to be possible, causing one or several of those bit positions'values to be replaced with new unique and distinctive values and repeating the exhaustive search until it successfully evaluates all of the most likely fault patterns and all of the fault patterns with few bits.

19. The computing device of any one of claims 10-18, wherein the data stored in memory includes raw data and metadata.

20. A method of generating a signature code, the method comprising:
assigning bit patterns to each bit position of a data block, wherein each bit pattern is unique with respect to all of the other bit patterns;
selecting a set of expected fault patterns;
conducting an exhaustive search of the selected set of expected fault patterns to identify fault patterns in which the bit patterns representing each bit position of the data block combine in ways which cause two or more matches to be possible;
replacing at least one of the bit patterns associated with a bit in fault in the identified fault patterns to be replaced with a new bit pattern; and
repeating the steps of conducting the exhaustive search and replacing at least one of the bit patterns until the exhaustive search is completed without finding a combination that causes two or more matches.

21. The method of claim 20, wherein the selecting a set of fault patterns includes selecting a set of fault patterns that includes most likely to occur fault patterns and fault patterns with few bits.

22. The method of claim 21, wherein the conducting an exhaustive search comprises applying each of the fault patterns to the data block, attempting to correct the data block using signed parity correction, and determining whether multiple candidate corrections are found.

23. The method of any one of claims 20-22, wherein a set of available permutations of bit patterns is significantly more numerous than the set of faults which merit the exhaustive search.

24. The method of any one of claims 20-23, wherein resulting bit patterns are guaranteed to correct the faults which were selected in the set of expected fault patterns.

25. A method comprising:
receiving data;
calculating a signature for the data;
calculating a parity block, wherein the parity block is calculated for the data and the signature; and
storing the data, signature, and parity block in a memory.

26. The method of claim 25, wherein the parity block is calculated for the data.

27. The method of claim 25, wherein the parity block is calculated for the data and the signature.

28. The method of any one of claims 25-27, further comprising:
receiving a request for the data;
responsive to receiving the request for the data:
retrieving the data, signature, and parity block from the memory;
recalculating the signature and parity block from the retrieved data;
comparing the retrieved signature and parity block with the recalculated signature and parity block; and
responsive to detecting a discrepancy between the retrieved signature and parity block with the recalculated signature and parity block:
using the parity block to reconstruct each sub-block of the data retrieved from the memory as a candidate correction and a candidate signature for each reconstructed sub-block;
responsive to determining that exactly one candidate correction results in a candidate signature that matches the retrieved signature, returning corrected data based on the exactly one candidate correction; and
responsive to determining that there is not exactly one candidate correction that results in a candidate signature that matches the retrieved signature, returning an error.
